(19) United States
(12) Patent Application Publication
(10) Pub. No.: US 2016/0109051 A1
(43) Pub. Date: Apr. 21, 2016

(54) TENSIONING OR PIPE CLAMP

(71) Applicant: STRAUB WERKE AG, Wangs (CH)

(72) Inventors: Damir Sudar, Bad Ragaz (CH); Hubert Mannhart, Sargans (CH)

(21) Appl. No.: 14/786,978

(22) PCT Filed: May 22, 2014
(86) PCT No.: PCT/IB2014/061616

§ 371 Date: Dec. 12, 2015

(30) Foreign Application Priority Data
Jun. 14, 2013 (CH) 01120/13

(51) Int. Cl. F16L 55/18; F16L 25/00; F16L 25/06; F16L 55/172

(52) U.S. Cl. CPC F16L 55/18; F16L 55/172; F16L 25/0018; F16L 25/06

(57) ABSTRACT

The invention relates a tensioning or pipe clamp with a housing (22) comprising a longitudinal slot (23), wherein the regions of the housing (22) lying opposite one another at the longitudinal slot (23) are constituted as bent brackets (24, 26), and with a tensioning mechanism (32) for tightening the housing (22). The tensioning mechanism (32) comprises a first bolt (33) and a second bolt (35), which are each provided in the brackets (24, 26), and a tensioning means (36) which is held in the first bolt (33) and can be swivelled relative to the second bolt (35). The tensioning mechanism (32) also comprises a distance part (42), which comprises a contact section (43) which can be brought into contact with a contact region (40) of the second bolt (35), and a feed-through opening (46) for the tensioning means (36), said feed-through opening being spaced apart from the contact section (43) of the distance part (42).

The invention relates to a tensioning or pipe clamp according to the preamble of claim 1.

Generic tensioning or pipe clamps are used for example to connect two pipe ends facing one another. The tensioning or pipe clamp comprises a deformable housing comprising at least one longitudinal slot, as well as a tensioning mechanism for tightening the housing, said tensioning mechanism engaging at the regions of the housing lying opposite one another at the longitudinal slot. The tensioning or pipe clamp is placed in the non-tightened state around the pipe ends to be connected and is then tightened by means of the tensioning mechanism. The longitudinal slot runs essentially parallel to the axes of the pipe ends to be connected.

Such tensioning or pipe clamps are also used as a repair clamp in the case of pipe damage, for example when a pipeline is or has become damaged in its shell region and then, for example, leaks or is untight in this damaged shell region. Mounted pipelines or pipelines laid underground are often accessible only to a limited extent or with difficulty. It is therefore essential that the used tensioning or pipe clamps can be opened wide, i.e. the at least one longitudinal slot can easily be increased in size and then easily reduced in size. The greater the possible opening range of the tensioning or pipe clamp, the closer a tensioning means, e.g. a tensioning screw, lying tangential to the outer side of the pipe lies to the outer side of the pipe. The regions of the housing lying opposite one another at the longitudinal slot must therefore have a minimum spacing for the connection of these regions.

A tensioning or pipe clamp is known from U.S. Pat. No. 6,830,268 B2, which comprises a deformable housing comprising at least one longitudinal slot. The regions of the housing lying opposite one another at the longitudinal slot are constituted as bent brackets. These brackets comprise, spaced apart from the essentially cylindrical portion of the housing, introduction slots for tensioning means of a tensioning mechanism, said introduction slots being open at the free end of the brackets and penetrating these brackets transversely. The tensioning means is a tensioning screw with a locknut. Furthermore, the tensioning mechanism comprises two tensioning rails running transversely with respect to the tensioning means and therefore parallel to the longitudinal extension of the brackets, said tensioning rails being penetrated by the tensioning means and being able to be brought into contact with the outer sides of the brackets each facing away from one another. A free space is created by the spacing of the tensioning means with respect to the essentially cylindrical portion of the housing or with respect to the outer side of the pipe, so that the longitudinal slot can have a large opening range during the arrangement of the tensioning mechanism.

A drawback with the known solution is that the arrangement of the tensioning mechanism is difficult in the state in which the tensioning or pipe clamp is placed around the pipe or the pipeline. The brackets must on the one hand be pressed together with two hands and at the same time the tensioning mechanism has to be arranged on the brackets. In addition, the hollow spaces formed by the brackets have to be filled with a filler material, in order that the brackets have sufficient rigidity, especially in the tightened state of the tensioning or pipe clamp. If the brackets were not to have sufficient rigidity with this known solution, the tensioning means of the tensioning mechanism and the brackets would be deformed beyond a permissible amount, since the tensioning means would have to take up, apart from the tensile/compressive forces, also force components of the acting moment forces. Self-evidently, such a tensioning or pipe clamp is costly and material-intensive in production, which has an adverse impact especially on the production costs for the tensioning or pipe clamp.

A tensioning or pipe clamp with a deformable housing comprising at least one longitudinal slot and with a tensioning mechanism for tightening the housing is known from EP 1 954 970 B1.

The regions of the housing lying opposite one another at the longitudinal slot are constituted as bent brackets. The tensioning mechanism comprises a first bolt and a second bolt, which are each provided in the brackets, and at least one tensioning means, here a tensioning screw, extending transversely through the first bolt, which is held in or on the first bolt and can be swivelled relative to the second bolt. The second bolt comprises at least one introduction slot, into which the tensioning means can be swivelled. The tensioning means can be tightened following the swivelling of the tensioning means.

This known tensioning or pipe clamp is easy to use, but has a limited opening range for the longitudinal slot.

The problem of the present invention, therefore, is to provide a tensioning or pipe clamp which does not exhibit the aforementioned drawbacks and in particular can be opened wide, can be used easily and can be produced at a favourable manner.

The problem is solved by the features of independent claim 1. Advantageous developments are presented in the figures and in the dependent claims.

According to the invention, the tensioning mechanism also comprises a distance part which comprises a contact section, which in the tightened state of the tensioning or pipe clamp can be brought into contact with the contact region of the second bolt, and a feed-through opening for the tensioning means, which is spaced apart from the contact section of the distance part.

The distance part and the tensioning means thus form a hook-shaped element, which can be placed zonally around the second bolt. As a result of the feed-through opening for the tensioning means, said feed-through opening being spaced apart from the contact section of the distance part, this tensioning means does not lie, even in the tightened state of the tensioning or pipe clamp, in a plane orientated tangential to the essentially cylindrical housing or to the outer side of the pipe, but at an angle thereto. Sufficient free space is thus created between the tensioning means and the housing or the outer side of the pipe, so that the brackets for the arrangement of the tensioning mechanism can lie much farther apart than in EP 1 954 970 B1. The longitudinal slot which can thus be opened to a greater extent greatly simplifies the assembly of the tensioning or pipe clamp according to the invention, without noticeably increasing the production costs compared to this known solution.

The tensioning means is advantageously a tensioning screw with a screw head as an actuating means for the tensioning screw. Alternatively, a threaded rod for example is used as a tensioning means, which for example comprises two nut elements, e.g. locknuts, disposed at a distance from one another. It is conceivable to fix one of these nut elements in one of the end regions of the threaded rod, for example by means of solder, adhesive or at least one weld point.

A rear-grip section for the zonal rear-gripping of the second bolt in the tightened state of the tensioning or pipe clamp is preferably provided on the distance part adjacent to the contact section of the distance part, at a free end region facing away from the feed-through opening, as a result of which slipping-away of the distance part during the tightening of the tensioning means is prevented.

The contact region of the second bolt is preferably flattened at least zonally, as a result of which the contact area with a distance part is enlarged, the latter advantageously having a plane contact region. For example, distance parts with an essentially rectangular embodiment, for example from a standard semi-finished product, can thus be used, which enables favourable production costs for the distance part and therefore for the tensioning or pipe clamp.

The distance part preferably comprises a first leg and a second leg set off at an angle with respect to the first leg, wherein the contact section of the distance part is provided on the first leg. Such a distance part is distinguished by high rigidity even with small material thicknesses.

The feed-through opening of the distance part is advantageously also provided in the first leg of the distance part, so that the second leg has the full material thickness over its entire longitudinal extension in order to take up occurring forces.

The second leg is advantageously constituted such that the latter takes up a part of the forces acting on the tensioning means, in particular the force components of the moment forces acting on the latter. In particular, such an embodiment prevents a deformation, e.g. bowing, of the tensioning means even under high loads or tensional forces.

The second leg of the distance part preferably has a longitudinal extension which is greater than the sum of the spacing between the first bolt and the second bolt in the non-tightened state of the tensioning or pipe clamp and the diameter of one of the bolts. This thus ensures that the second leg of the distance part rests against the first bolt during the entire tightening process. In addition, the second leg can thus take up, in particular, a large part of the force components of the moment forces acting on the tensioning means, so that the tensioning means essentially takes up only tensile or compressive forces, for which the tensioning means is in itself also designed.

The tensioning mechanism preferably comprises at least two tensioning means advantageously disposed beside one another in the direction of the longitudinal slot, wherein at least one of the tensioning means comprises a distance part. In such an embodiment, the tensioning means each take up a part of the tensional forces applied by the tensioning mechanism and can thus be constituted smaller in size or even of adequate, but lesser material quality. Furthermore, the tensioning means can be tightened differently from one another, which is advantageous for example when connecting pipes with different external diameters. Each tensioning means advantageously comprises a distance part, which enables particularly advantageous tightening of the tensioning or pipe clamp.

The tensioning mechanism preferably comprises at least three tensioning means advantageously disposed beside one another in the direction of the longitudinal slot, wherein at least one of the tensioning means comprises a distance part. The distance part on the at least one tensioning means is passed over the second bolt for the tightening of the tensioning or pipe clamp and is at least partially tightened in a first step. The remaining tensioning means are then brought into the appropriate position for gripping at the rear of the second bolt and are also tightened. If need be, the tensioning means with the distance part is then tightened up again or tightened further. In such an embodiment, the tensioning means each take up a part of the tensional forces applied by the tensioning mechanism and can thus be constituted smaller in size or even of adequate, but lesser material quality. Furthermore, the two outer tensioning means can in particular be tightened differently from one another, which is advantageous for example when connecting pipes with different external diameters. The middle tensioning means, i.e. the tensioning means disposed between the two outer tensioning means, is advantageously provided with the distance part, which ensures easy handling of the tensioning or pipe clamp.

Alternatively, two or each of the at least three tensioning means are each provided with a distance part.

At least one alignment element is advantageously provided, which is mounted in or on at least two distance elements disposed adjacent to one another. A correct alignment of the distance parts, even in the non-tightened state of the tensioning or pipe clamp, is thus ensured for straightforward assembly of the latter. The at least one alignment element can serve as an assembly aid, e.g. as a handle, which simplifies the manual bringing-together of the brackets relative to one another and therefore the handling of the tensioning or pipe clamp. The at least one alignment element is guided for example in cutouts in the distance parts and is also advantageously mounted rotatably. Alternatively, the alignment element is fixed to the distance parts.

The first bolt is preferably constituted multi-part in its longitudinal extension, so that differences during the tightening of the tensioning or pipe clamp can easily be compensated for. Each tensioning means is advantageously held in a separate bolt part, so that each tensioning means can be swivelled independently of the other tensioning means. In this embodiment, the handling and the flexibility of the tensioning or pipe clamp are additionally improved.

At least one threaded section for the at least one tensioning means is advantageously provided in the first bolt, wherein the tensioning means advantageously provided with a correspondingly constituted threaded region can engage in the threaded section of the first bolt. The arrangement of a locknut on the tensioning means in order to tighten the tensioning or pipe clamp with the tensioning mechanism thus becomes unnecessary.

The first bolt is advantageously a hollow bolt, which has a low weight with a sufficient stability thereof. At least one threaded part with a threaded section for the at least one tensioning means is also advantageously disposed in the hollow bolt. Such a threaded part is for example a nut, which is disposed non-displaceably in the hollow bolt, preferably in its longitudinal extension. For example, by means of individual studs, e.g. clinch points, suitably provided on the hollow bolt, the nut is fixed to the latter. Alternatively, the nut is fixed by solder, adhesive or at least one weld point in the hollow bolt.

Alternatively, threaded sections for receiving the tensioning means provided with a thread are provided in the wall of the penetration opening in the hollow bolt.

The rear-grip section of the distance part preferably has a smaller material thickness than the contact section of the distance part, as a result of which the engagement during the rear-gripping of the second bolt is also improved. In addition, such a rear-grip section can be deformed better than with an identical material thickness, which enables simpler production of a distance element thus constituted.

Further advantages, features and details of the invention emerge from the following description, in which examples of embodiment of the invention are described by reference to the drawings. The features mentioned in the claims and in the description may be essential to the invention in each case individually in themselves or in any combination.

The list of reference numbers, as also the technical content of the claims and the figures, is a component part of the disclosure. The figures are described in an interrelated and overlapping manner. Identical reference numbers signify identical components.

In the figures:

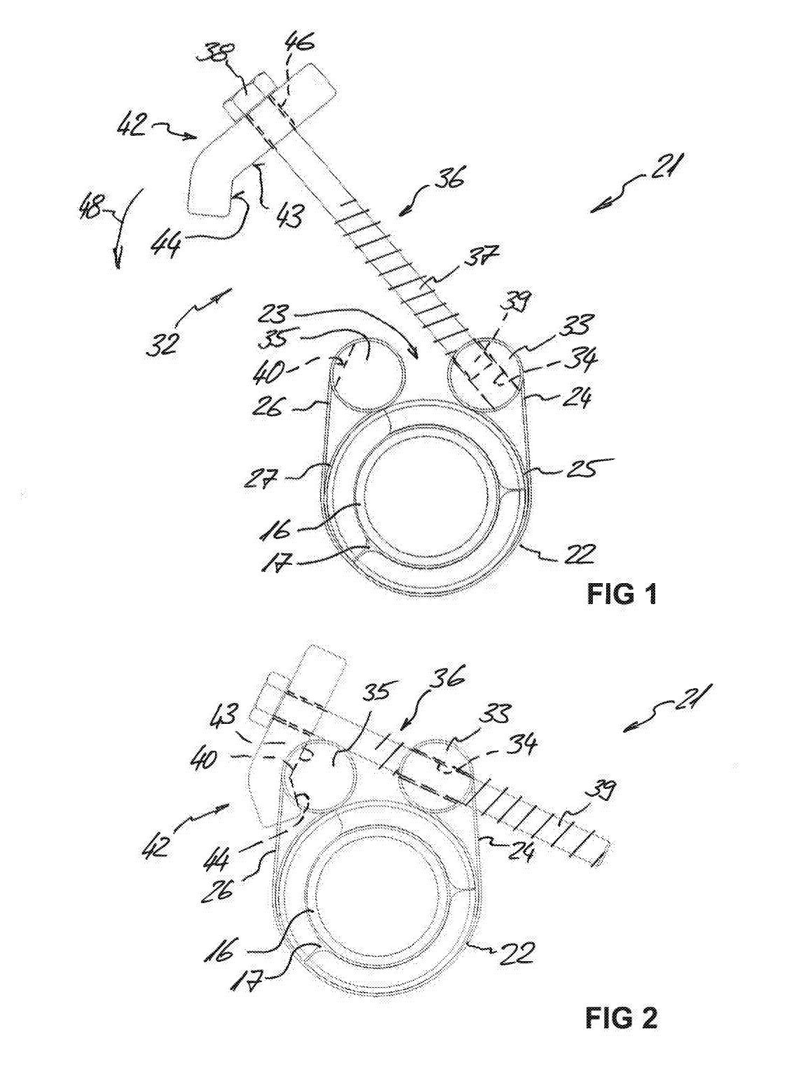

FIG. 1 shows a first embodiment of a tensioning or pipe clamp according to the invention in the non-tightened state in a side view.

FIG. 2 shows the tensioning or pipe clamp according to FIG. 1 in the tightened state in a side view,

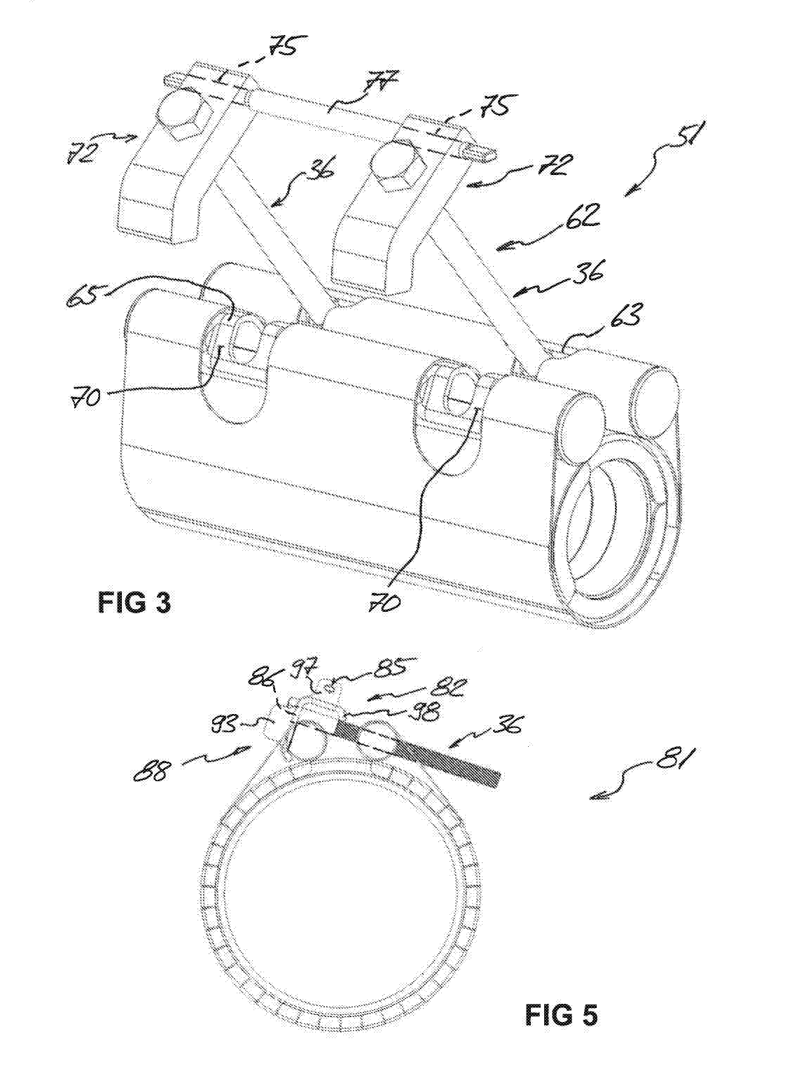

FIG. 3 shows a second embodiment of a tensioning or pipe clamp according to the invention in the non-tightened state in a perspective view,

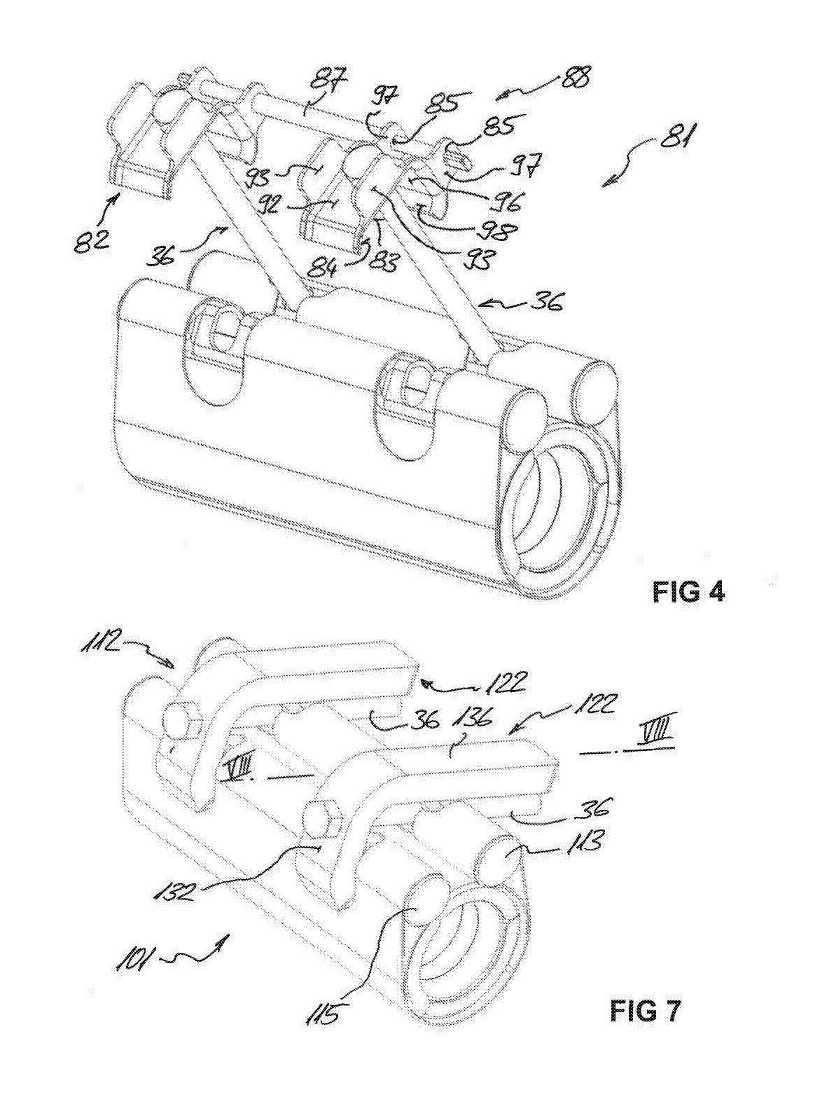

FIG. 4 shows a third embodiment of a tensioning or pipe clamp according to the invention in the non-tightened state in a perspective view,

FIG. 5 shows the tensioning or pipe clamp according to FIG. 4 in the tightened state in a side view,

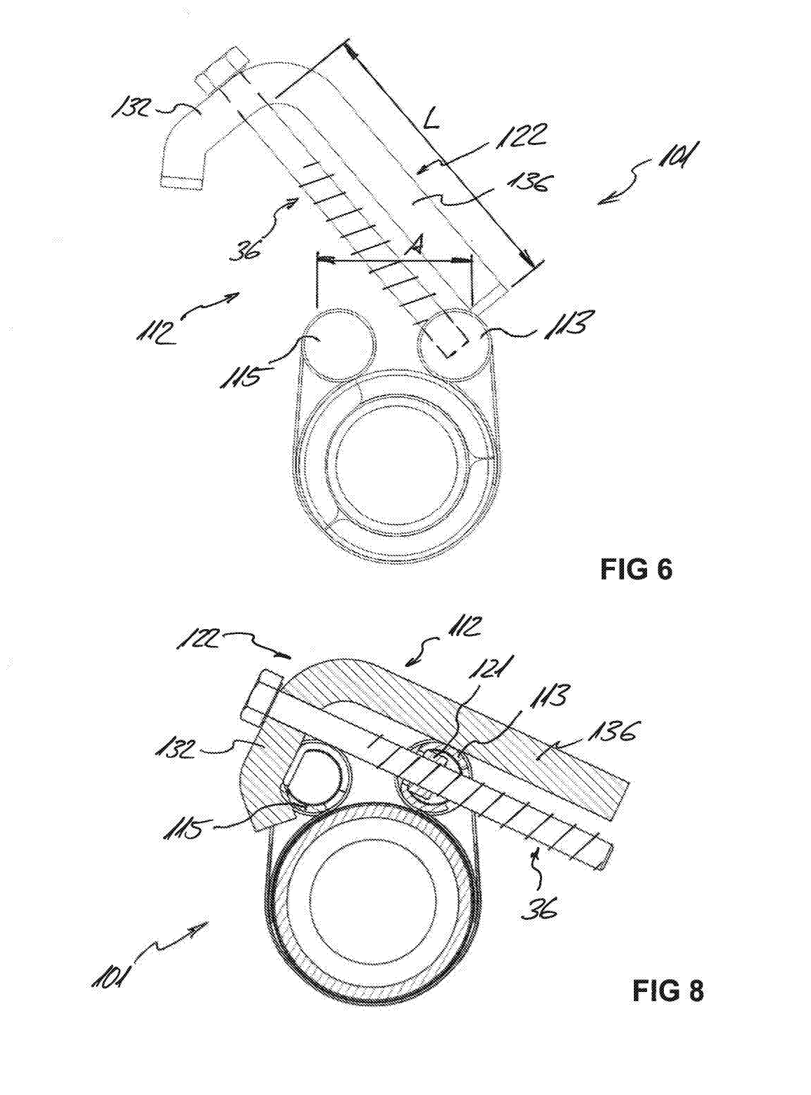

FIG. 6 shows a fourth embodiment of a tensioning or pipe clamp according to the invention in the non-tightened state in a side view,

FIG. 7 shows the tensioning or pipe clamp according to FIG. 6 in the tightened state in a perspective view,

FIG. 8 shows a cross-section through the tensioning or pipe clamp according to FIG. 7 along line VIII-VIII,

FIG. 9 shows a fifth embodiment of a tensioning or pipe clamp according to the invention in the tightened state in a perspective view,

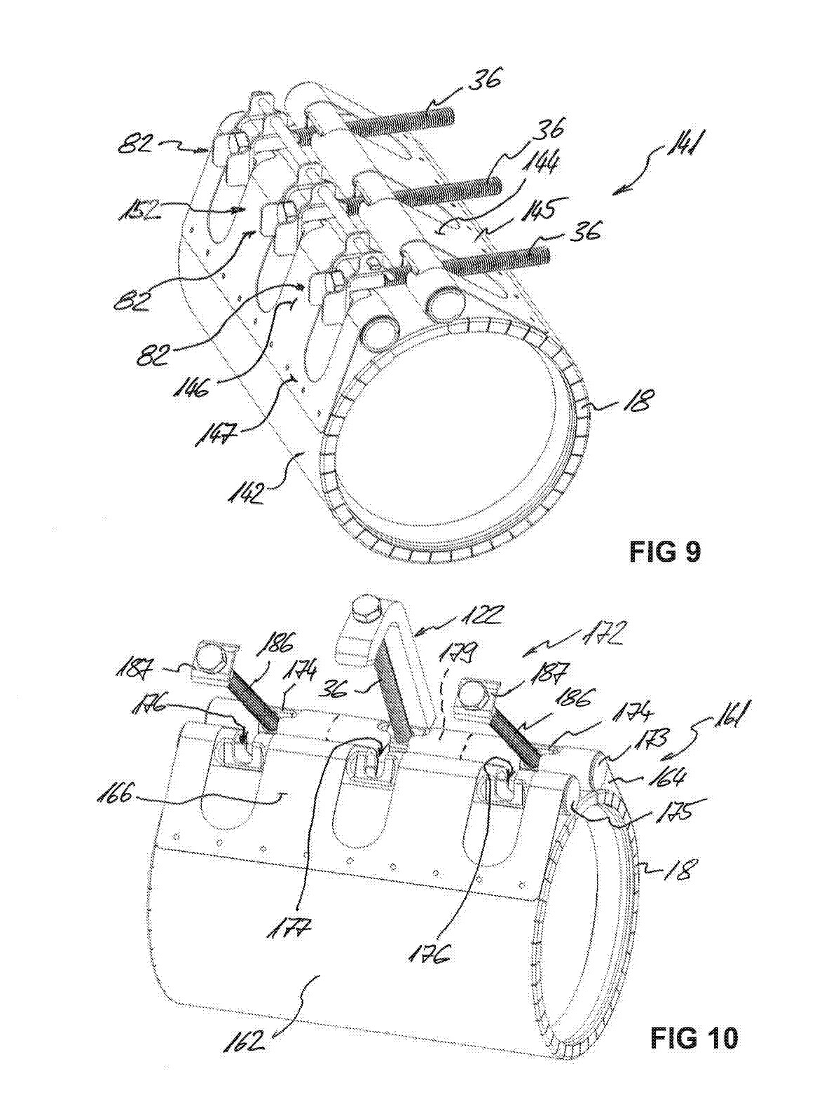

FIG. 10 shows a sixth embodiment of a tensioning or pipe clamp according to the invention in the non-tightened state in a perspective view,

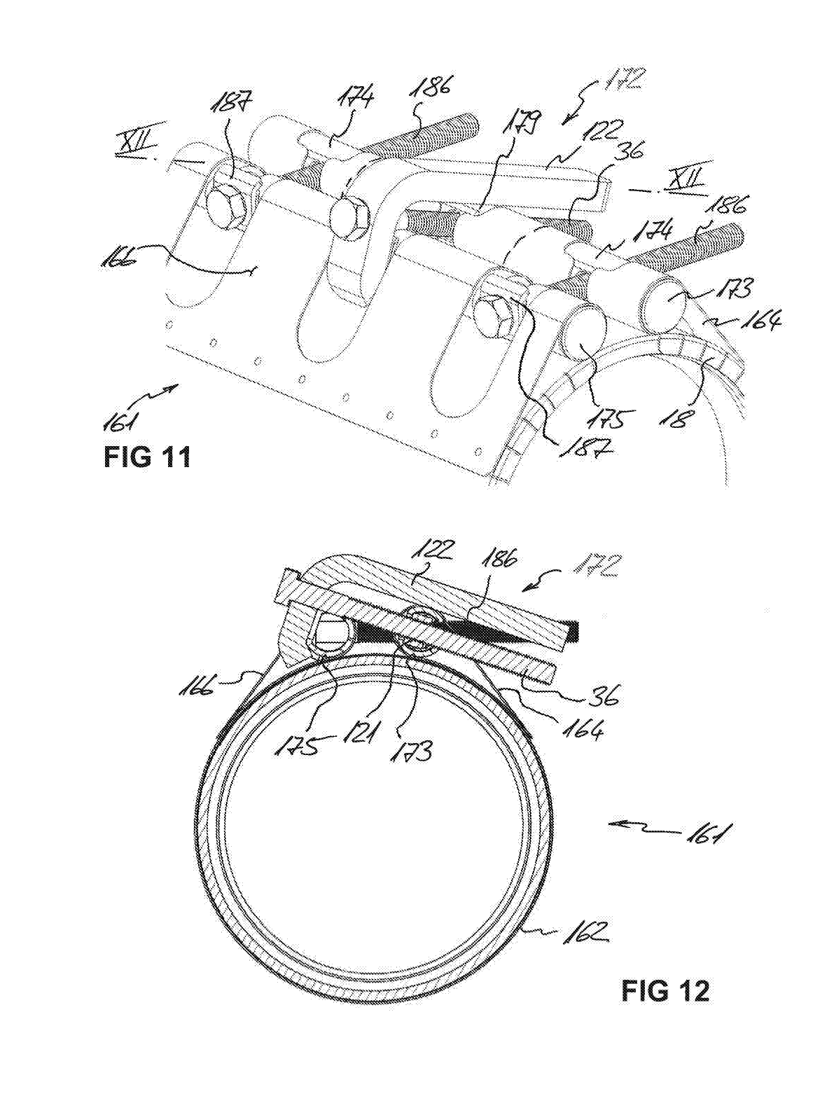

FIG. 11 shows the tensioning or pipe clamp according to FIG. 10 in the tightened state in a perspective view,

FIG. 12 shows a cross-section through the tensioning or pipe clamp according to FIG. 11 along line XII-XII, and

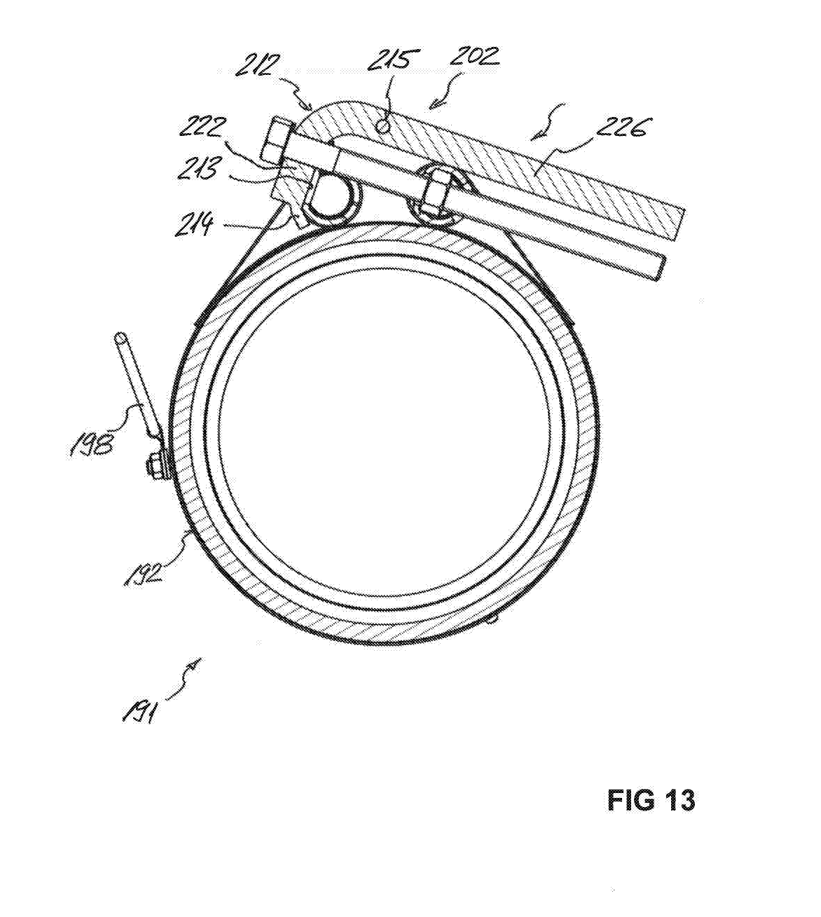

FIG. 13 shows a seventh embodiment of a tensioning or pipe clamp according to the invention in the tightened state in a cross-sectional representation.

Tensioning or pipe clamp 21 shown in FIGS. 1 and 2 comprises a deformable, essentially cylindrical housing comprising at least one longitudinal slot 23. Housing 22 is produced from a band-shaped material, e.g. a steel band. The regions of housing 22 lying opposite one another at longitudinal slot 23 are constituted as bent brackets 24 and 26. In this example of embodiment, respective free end region 25 and 27 of brackets 24 and 26 is fixed in each case in a friction-locked and/or form-fit in a manner inside housing 22, e.g. by clinches or by means of weld points.

A sealing insert 17 can be provided in housing 22, said sealing insert lying in a sealing manner against the outer side of pipe 16 surrounded by tensioning or pipe clamp 21 in the tightened state of the tensioning or pipe clamp 21.

Tensioning or pipe clamp 21 also comprises a tensioning mechanism 32 for tightening housing 22, said tensioning mechanism comprising a first bolt 33 provided in bracket 24 and a second bolt 35 provided in the other bracket 26 as well as tensioning means 36 extending transversely through first bolt 33. First bolt 33 and/or second bolt 35 are constituted as solid bolts, wherein for example a cylindrical semi-finished product, e.g. made of steel, is used. Alternatively, first bolt 33 and/or second bolt 35 are constituted as hollow bolts.

Tensioning means 36 is a tensioning screw with a screw shaft 37 provided at least zonally with an external thread and with a screw head 38 at one end of shaft 37. First bolt 33 is provided with a bore penetrating the latter transversely, said bore being provided with an inner thread as a threaded section 34. In FIG. 1, free end region 39 of screw shaft 37 lying opposite screw head 38 is screwed into threaded section 34, so that tensioning means 36 is held to first bolt 33 in this state. Tensioning means 36 can be swivelled relative to second bolt 35.

Tensioning mechanism 32 also comprises a distance part 42, which comprises a contact section 43 comprising a plane section. In the tightened state of tensioning or pipe clamp 21, contact section 43 can be brought into contact with contact region 40 of second bolt 35. Distance part 42 also comprises a feed-through opening 46 for tensioning means 36. Feed-through opening 46 is spaced apart from contact section 43 of distance part 42.

Provided on distance part 42, adjacent to contact section 43 of distance part 42 at a free end region facing away from feed-through opening 46, is a rear-grip section 44 for the zonal rear-gripping of second bolt 35 in the tightened state of tensioning or pipe clamp 21.

In the non-tightened state, tensioning or pipe clamp 21 is placed around pipe 16. Tensioning means 36 is then swivelled relative to second bolt 35 in the direction of arrow 48, so that distance part 42 comes into a position gripping second bolt 35 at the rear. Tensioning means 36 is then actuated, wherein free end region 39 penetrates first bolt 33. Distance part 42 comes into contact zonally with second bolt 35 and housing 22 with sealing insert 17 is pressed against pipe 16.

In the case of tensioning or pipe clamp 51 shown in FIG. 3, tensioning mechanism 62 comprises two tensioning means 36 disposed beside one another with a spacing. Tensioning means 36 are held in a first bolt 63 constituted as a hollow bolt. Second bolt 65 is also constituted as a hollow bolt and comprises flattened contact regions 70 for distance parts 72. Each tensioning means 36 comprises a distance part, which is constituted for the most part corresponding to distance part 42 described in FIGS. 1 and 2. Distance parts 72 constituted identically here each comprise a through-hole 75 at their end region facing away from rear-grip section 74, said through-hole running here transversely with respect to the longitudinal extension of tensioning means 36. An alignment element 77 is provided rotatably mounted in these through-holes 75. Alignment element 77 can serve as a handle, so that tensioning or pipe clamp 51 can be a fitted more easily.

Tensioning or pipe clamp 81 represented in FIGS. 4 and 5 differs from tensioning or pipe clamp 51 shown in FIG. 3 solely by the embodiment of distance parts 82 of tensioning mechanism 88. Distance parts 82 are constituted identically here and are produced for example as stamped/bent parts from a flat material, preferably made of steel. Distance part 82 comprises a first leg 92 and a second leg 96 set off at an angle of approx. 90° with respect to first leg 92.

Contact section 83 and rear-grip section 84 of distance part 82 are provided on the first leg 92. Feed-through opening 86 of distance part 82 for tensioning means 36 is also provided in first leg 92 of distance part 82. Projecting outwards from the side of first leg 92 of distance part 82 facing away from contact section 83 of distance part 82 are, in each case, first stiffening ribs 93 disposed at the edge regions. Also provided on second leg 96 are two second stiffening ribs 97 each disposed at the edge regions, said stiffening ribs 97 also projecting outwards. An alignment element 87 is provided in each case in through-holes 85 in second stiffening ribs 97. A support section 98 is provided at the free end of second leg 96. In the tightened state of tensioning or pipe clamp 81, this support section 98 comes zonally into contact in a supporting manner with the outer side of tensioning means 36.

Tensioning mechanism 112 of tensioning or pipe clamp 101 shown in FIGS. 6 to 8 comprises a first bolt 113, which is constituted as a U-shaped hollow bolt and is fixed in the nut as threaded part 121 with a threaded section for tensioning means 36. Second bolt 115 is also constituted here as a hollow bolt.

Distance parts 122 of tensioning or pipe clamp 101, which are constituted identically here, each comprise, like previously described distance parts 82, a first leg 132 and a second leg 136 set off at an angle. In contrast with distance parts 82, distance parts 122 are constituted essentially solid, as a result of which additional stiffening ribs can be dispensed with.

Second Leg 136 comprises, proceeding from the inner side of first leg 132, a longitudinal extension L which is greater than the sum A of the spacing between first bolt 113 and second bolt 115 in the non-tightened state of tensioning or pipe clamp 101 and the diameter of one of bolts 113 or 115.

In the case of tensioning or pipe clamp 141 according to FIG. 9, respective free end regions 145 and 147 of brackets 144 and 146 are for example each fixed in a friction-locked and/or form-fit manner on the outside of housing 142. An anchoring ring 18 is provided in each case at the free ends of housing 142, said ends running in the pipe direction (only one visible in this form of representation), the free edges of said anchoring ring being able to penetrate, in the non-tightened state of tensioning or pipe clamp 141, externally into the pipe shell depending on the type of material of pipe 16 or being able to engage in the latter and thus prevent a displacement of pipe 16 relative to tensioning or pipe clamp 141.

Tensioning mechanism 152 of tensioning or pipe clamp 141 comprises three tensioning means 36 on which a distance part 82 is provided in each case. With reference to the embodiment and details of distance parts 82 shown here, reference is made to the comments made in connection with FIGS. 4 and 5, which each also apply to distance part 82 shown here.

In FIGS. 10 to 12, tensioning mechanism 172 of tensioning or pipe clamp 161 comprises three tensioning means 36 and 186, which are disposed beside one another. A distance part 122 is provided on central tensioning means 36. A rear-grip part 187 is provided in each case on outer tensioning means 186.

First bolt 173 is constituted multi-part in its longitudinal extension, wherein tensioning means 36 is held in central bolt part 179 and tensioning means 186 are each held in outer bolt parts 174. Tensioning means 36 and 186 can thus be swivelled independently of one another relative to second bolt 175.

Second bolt 175 comprises two outer introduction slots 176 for at least zonally receiving outer tensioning means 186 and a further introduction slot 177 disposed between outer introduction slots 176.

Once the tensioning or pipe clamp 161 has been placed around a pipe, central tensioning means 36 is swivelled in the direction of second bolt 175, until distance part 122 disposed on this tensioning means 36 grips zonally at the rear of second bolt 175 or is located in a rear-gripping position. Central tensioning means 36 is then tightened to a first tightening state.

The other tensioning means 186 are now swivelled—simultaneously or temporarily offset with respect to one another—in the direction of second bolt 175, until rear-grip parts 187 disposed on these tensioning means 186 grip zonally at the rear of second bolt 175 or are located in a rear-gripping position. In this position, tensioning means 186 penetrate with their shaft into outer introduction slots 176 of second bolt 175. Since the spacing between brackets 164 and 166 of housing 162 has already been reduced, tensioning means 186, now orientated almost tangential to the outer side of the pipe, no longer hinder the further tightening process. All tensioning means 36 and 186 are now tightened until the finally desired tightening state is reached.

Tensioning or pipe clamp 191 according to FIG. 13 is constituted essentially analogous to tensioning or pipe clamp 101 (FIGS. 6 to 8), for which reason only the differences will be explained below. In contrast, distance part 212 of tensioning mechanism 202 comprises a rear-grip section 214, which has a smaller material thickness than contact section 213 adjacent thereto. Rear-grip section 214 is thus constituted nose-shaped at the free end of distance part 212. In contrast with distance part 122 of tensioning or pipe clamp 101, the material thickness of first leg 222 and of second leg 226 of distance part 212 has also been reduced. Provided in second leg 226 is a through-hole 215 for receiving an alignment element (not represented here).

A rear-grip section with a small material thickness can also be provided with the other embodiments of the invention.

Also disposed on housing 192 is an additional handle 198 which additionally simplifies the handling of tensioning or pipe clamp 191.

LIST OF REFERENCE NUMBERS

| | |
|---|---|
| 16 | Pipe |
| 17 | Sealing insert |
| 18 | Anchoring ring |
| 21 | Tensioning or pipe clamp |
| 22 | Housing |
| 23 | Longitudinal slot |
| 24 | Bracket |
| 25 | Free end region of 24 |
| 26 | Bracket |
| 27 | Free end region of 26 |
| 32 | Tensioning mechanism |
| 33 | 1^{st} bolt |
| 34 | Threaded section of 33 |
| 35 | 2^{nd} bolt |
| 36 | Tensioning means |
| 37 | Screw shaft |
| 38 | Screw head |
| 39 | Free end region of 37 |
| 40 | Contact region of 35 |
| 42 | Distance part |
| 43 | Contact section of 42 |
| 44 | Rear-grip section |
| 46 | Feed-through opening in 42 |
| 48 | Arrow |
| 51 | Tensioning or pipe clamp |
| 62 | Tensioning mechanism |
| 63 | 1^{st} bolt |
| 65 | 2^{nd} bolt |
| 70 | Contact region of 65 |
| 72 | Distance part |
| 74 | Rear-grip section |
| 75 | Through-hole for 77 |
| 77 | Alignment element |
| 81 | Tensioning or pipe clamp |
| 82 | Distance part |
| 83 | Contact section of 82 |
| 84 | Rear-grip section |
| 85 | Through-hole in 97 |
| 87 | Alignment element |
| 88 | Tensioning mechanism |
| 92 | 1^{st} leg of 82 |
| 93 | Stiffening rib of 92 |
| 96 | 2^{nd} leg of 82 |
| 97 | Stiffening rib of 96 |
| 98 | Support section of 96 |
| L | Length of 136 |
| A | Total opening distance |
| 101 | Tensioning or pipe clamp |
| 112 | Tensioning mechanism |
| 113 | 1^{st} bolt |
| 115 | 2^{nd} bolt |
| 121 | Threaded part |
| 122 | Distance part |
| 132 | 1^{st} leg of 122 |
| 136 | 2^{nd} leg of 122 |
| 141 | Tensioning or pipe clamp |
| 142 | Housing |
| 144 | Bracket |
| 145 | Free end region of 144 |
| 146 | Bracket |
| 147 | Free end region of 146 |
| 152 | Tensioning mechanism |
| 161 | Tensioning or pipe clamp |
| 162 | Housing |
| 164 | Bracket |
| 166 | Bracket |
| 172 | Tensioning mechanisms |
| 173 | 1^{st} bolt |
| 174 | Outer bolt part |
| 175 | 2^{nd} bolt |
| 176 | Outer introduction slot |
| 177 | Inner introduction slot |
| 186 | Tensioning means |
| 187 | Rear-grip part |
| 191 | Tensioning or pipe clamp |
| 192 | Housing |
| 198 | Handle |
| 202 | Tensioning mechanism |
| 212 | Distance part |
| 213 | Contact section of 212 |
| 214 | Rear-grip section |
| 215 | Through-hole |
| 222 | 1^{st} leg of 212 |
| 226 | 2^{nd} leg of 212 |

1-11. (canceled)

12. A tensioning or pipe clamp with a deformable housing comprising at least one longitudinal slot, wherein the regions of the housing lying opposite one another at the longitudinal slot are constituted as bent brackets, and with a tensioning mechanism for tightening the housing, wherein the tensioning mechanism comprises a first bolt and a second bolt, which are each provided in the brackets, and at least one tensioning means extending transversely through the first bolt, which tensioning means is held in or on the first bolt and can be swivelled relative to the second bolt, characterised in that the tensioning mechanism also comprises a distance part, which comprises a contact section, which in the tightened stated of the tensioning or pipe clamp can be brought into contact with a contact region of the second bolt, and a feed-through opening for the tensioning means, said feed-through opening being spaced apart from the contact section of the distance part.

13. The tensioning or pipe clamp according to claim 12, characterised in that a rear-grip section for the zonal rear-gripping of the second bolt in the tightened state of the tensioning or pipe clamp is provided on the distance part adjacent to the contact section of the distance part.

14. The tensioning or pipe clamp according to claim 12, characterised in that the contact region of the second bolt is flattened at least zonally.

15. The tensioning or pipe clamp according to claim 12, characterised in that the distance part comprises a first leg and a second leg set off at an angle with respect to the first leg, wherein the contact section of the distance part and advantageously also the feed-through opening of the distance part are provided in the first leg of the distance part.

16. The tensioning or pipe clamp according to claim 15, characterised in that the second leg of the distance part has a longitudinal extension (L) which is greater than the sum (A) of the spacing between the first bolt and the second bolt in the non-tightened state of the tensioning or pipe clamp and the diameter of one of the bolts.

17. The tensioning or pipe clamp according to claim 12, characterised in that the tensioning mechanism comprises at least two tensioning means, wherein at least one of the tensioning means comprises a distance part.

18. The tensioning or pipe clamp according to claim 12, characterised in that the tensioning mechanism comprises at least three tensioning means, wherein at least one tensioning means, advantageously the central one, comprises a distance part.

19. The tensioning or pipe clamp according to claim 17, characterised in that at least one alignment element is provided, which is mounted in or on at least two distance elements disposed adjacent to one another.

20. The tensioning or pipe clamp according to claim 17, characterised in that the first bolt is constituted multi-part in its extension, wherein each tensioning means is advantageously held in a separate bolt part.

21. The tensioning or pipe clamp according to claim 12, characterised in that at least one threaded section for the at least one tensioning means is provided in the first bolt, wherein the first bolt is advantageously a hollow bolt, in which at least one threaded part with a threaded section for the at least one tensioning means is also advantageously disposed.

22. The tensioning or pipe clamp according to claim 13, characterised in that the rear-grip section of the distance part has a smaller material thickness than the contact section of the distance part.
